(19) United States
(12) Patent Application Publication
(10) Pub. No.: US 2026/0255125 A1
(43) Pub. Date: Aug. 27, 2026

(54) AUDIO SYSTEM AND METHOD

(71) Applicant: HARMAN BECKER AUTOMOTIVE SYSTEMS, INC., Novi, MI (US)

(72) Inventors: Philipp Maximilian KREJCI, Ettlingen (DE); Manfred NEUMANN, Kulmbach (DE); Friedrich VON TÜRCKHEIM, Hamburg (DE); Johannes KLEIN, Kehl (DE)

(21) Appl. No.: 19/535,376

(22) Filed: Feb. 10, 2026

(30) Foreign Application Priority Data
Feb. 26, 2025 (EP) 25160292.6

(51) Int. Cl. H04S 7/00; H04R 5/02; H04S 3/00

(52) U.S. Cl. CPC H04S 7/305; H04R 5/02; H04S 3/006; H04R 2430/20; H04S 2420/11

(57) ABSTRACT

An audio system utilizes an ambience analysis unit configured to identify early reflections and reverberation present in a first plurality of audio input signals or in processed versions of the first plurality of audio input signals, a weighting unit configured to weigh the early reflections identified in the first plurality of audio input signals or in the processed versions of the first plurality of audio input signals, and the reverberation identified in the first plurality of audio input signals or in the processed versions of the first plurality of audio input signals, and a merging unit configured to assign the weighted early reflections identified in the first plurality of audio input signals or in the processed versions of the first plurality of audio input signals to a first subset of a second plurality of audio output signals.

### CROSS-REFERENCE TO RELATED APPLICATIONS

This application claims priority benefit to European Patent Application Number 25160292.6 entitled “AUDIO SYSTEM AND METHOD”, filed February 26, 2025. The subject matter of this related application is hereby incorporated by reference herein in its entirety.

### FIELD OF THE VARIOUS EMBODIMENTS

The disclosure relates to an audio system and related method, in particular an audio system and method for dynamic creation and/or adaptation of ambience for an audio signal.

### DESCRIPTION OF THE RELATED ART

By extending an audio signal with surround or 3D information, e.g. adjusting ambience already existent in the audio signal and/or adding an ambience effect to an audio signal that matches ambience already existent in the audio signal, thereby simulating a certain listening environment, the listening experience of a user to whom the audio signal is presented can be significantly increased. An audio signal may be expanded, e.g., in the context of an upmixing process, by adjusting ambience effects present in the original audio signal, adding ambience effects which match the original audio signal, or by creating additional ambience effects or signals which match ambience that is already present in the existing audio signal. Acoustically simulating a concert hall, church, jazz club, or any other kind of listening environment by suitably adding and reproducing matching ambience effects, however, can be challenging. The resulting audio signal may comprise unwanted artifacts, may not be satisfying to listen to, and high computational load may be required to generate an extended audio signal.

There is a need for an audio system and related method that allows simulation of a listening environment by extending an audio signal with surround or 3D information, resulting in a highly satisfying listening experience for a listener, while requiring comparably little computational load.

### SUMMARY

An audio system includes an ambience analysis unit configured to identify and/or analyze early reflections and reverberation present in a first plurality of audio input signals or in processed versions of the first plurality of audio input signals, a weighting unit configured to weigh the early reflections identified in the first plurality of audio input signals or in the processed versions of the first plurality of audio input signals, and the reverberation identified in the first plurality of audio input signals or in the processed versions of the first plurality of audio input signals, and a merging unit configured to assign the weighted early reflections identified in the first plurality of audio input signals or in the processed versions of the first plurality of audio input signals to a first subset of a second plurality of audio output signals, and to assign the weighted reverberation identified in the first plurality of audio input signals or in the processed versions of the first plurality of audio input signals to a second subset of the second plurality of audio output signals.

A method includes identifying and/or analyzing, by means of an ambience analysis unit, early reflections and reverberation present in a first plurality of audio input signals or in processed versions of the first plurality of audio input signals. The method further comprises weighting, by means of a weighting unit, the early reflections identified in the first plurality of audio input signals or in the processed versions of the first plurality of audio input signals, and the reverberation identified in the first plurality of audio input signals or in the processed versions of the first plurality of audio input signals. The method further comprises assigning, by means of a merging unit, the weighted early reflections identified in the first plurality of audio input signals or in the processed versions of the first plurality of audio input signals to a first subset of a second plurality of audio output signals, and assigning, by means of a merging unit, the weighted reverberation identified in the first plurality of audio input signals or in the processed versions of the first plurality of audio input signals to a second subset of the second plurality of audio output signals.

Other systems, features and advantages of the disclosure will be or will become apparent to one with skill in the art upon examination of the following detailed description and figures. It is intended that all such additional systems, methods, features and advantages included within this description, be within the scope of the disclosure and be protected by the following claims.

### BRIEF DESCRIPTION OF THE DRAWINGS

The arrangements and methods may be better understood with reference to the following description and drawings. The components in the figures are not necessarily to scale, emphasis instead being placed upon illustrating the principles of the disclosure. Moreover, in the figures, referenced numerals designate corresponding parts throughout the different views.

FIG. 1 schematically illustrates an audio system according to embodiments of the disclosure.

FIG. 2 schematically illustrates an audio system according to further embodiments of the disclosure.

FIG. 3 schematically illustrates an audio system according to even further embodiments of the disclosure.

FIG. 4 schematically illustrates an audio system according to further embodiments of the disclosure.

FIG. 5 schematically illustrates a method according to embodiments of the disclosure.

### DETAILED DESCRIPTION

The audio system and related method according to the various embodiments described herein allow to simulate different listening environments. Only comparably little computational load is required, and the resulting audio signal is highly satisfying to listen to, as it comprises only few or even no artifacts. Instead of “blindly” processing an audio signal as is done in conventional audio systems, the audio system and method disclosed herein preform an “informed” processing on an audio signal. When applying spatial processing in order to enhance the immersive experience such as, for example, for an up-mixer in a vehicle or any other listening environment, adding a static amount of reverberation and early reflections may result in either excessive reverberation and/or early reflections if the original audio signal already included a large amount of reverberation and/or early reflections, or in an insufficient amount of reverberation and/or early reflections if, for example, the original audio signal does not include any reverberation and/or early reflections. By taking into account a level of reverberation and early reflections already present in the original audio signal, the resulting, (up-mixed) audio signal always includes a satisfying level of reverberation and early reflections, resulting in a highly satisfying listening experience for a user of the audio system. Further, reverberation and early reflections included in an audio signal are generally characteristic for a specific type of listening environment. Adding a static amount of reverberation and early reflections may result in an audio output signal including reverberation and early reflections that are characteristic for a different type of listening environment, which does not match the originally intended type of listening environment. That is, ambience effects present in a modified audio output signal may no longer match ambience effects present in the original audio input signal at all, which is generally not desirable.

Generally, by adjusting reverberation and early reflections already present in an original audio signal, or by adding an appropriate amount and/or type (or class) of reverberation and early reflections to an original audio signal, the listening experience for a user listening to the audio signal can be significantly increased. Especially multi-channel playback provides the possibility of providing the impression to the user that they are located at a certain location or event, while listening to a musical piece.

In order to improve the quality of a reproduced sound scene, the perception of the sound scene is often modeled as a combination of the foreground sound and the background sound, which are often also referred to as primary (or direct) and ambient (or diffuse) components, respectively. The primary components consist of point-like directional sound sources, whereas the ambient components are generally made up of diffuse environmental sound (reverberation and early reflections). Due to perceptual differences between the primary components and the ambient components, different rendering schemes are generally applied to the primary components and the ambient components for optimal spatial audio reproduction of sound scenes.

The audio system and related method disclosed herein, in contrast to conventional methods, analyze reverberation and early reflections already present in an original audio signal. Based on this analysis, any reverberation and early reflections already present in the original audio signal are suitably distributed to different channels of an (upmixed) version of the original audio signal, and, optionally, additional reverberation and early reflections may be suitably added to different channels of the upmixed version of the original audio signal.

A musical piece including reverberation generally includes a specific class of reverberation and early reflections. The reverberation and early reflections included in the musical piece generally have certain characteristics that are typical for the specific class of reverberation, e.g., long reverb tail, specific room modes, early reflections, etc. For example, a time delay for each reflection, and a level of each reflection are typical early reflection parameters. Decay time, and initial level of reverb tail are typical reverberation parameters. As a result, reverberation and early reflections may be added to the audio signal that match the reverberation and early reflections included in the original musical piece. That is, based on determined reverberation parameters and early reflection parameters, for example, matching artificial reverberation and early reflections may be added to the audio signal. For example, reverberation and early reflections typical for a small listening environment generally significantly differ from reverberation and early reflections typical for a medium-sized or large listening environment.

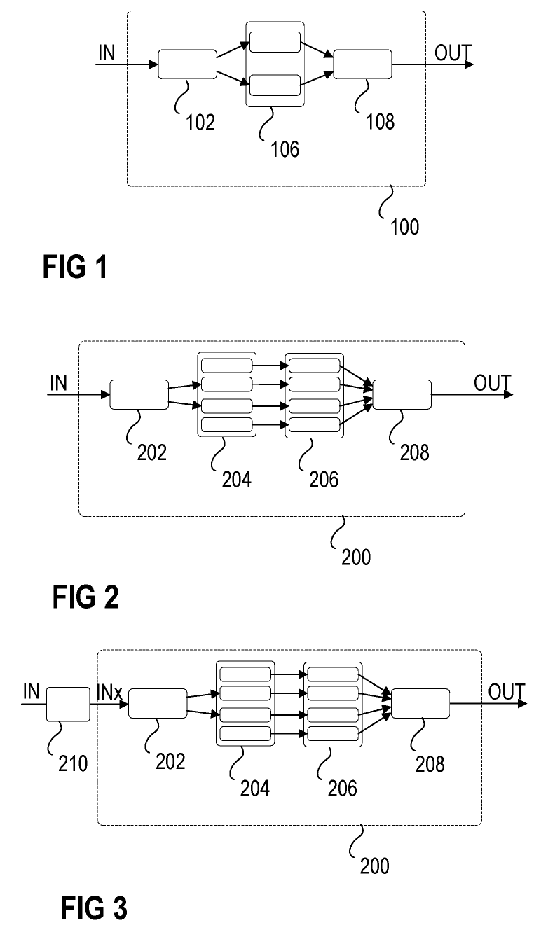

Now referring to FIG. 1, an audio system according to embodiments of the disclosure is schematically illustrated. The audio system 100 comprises an ambience analysis unit 102 configured to identify and/or analyze early reflections and reverberation present in a first plurality of audio input signals IN or in processed versions of the first plurality of audio input signals INx (processed versions of the first plurality of audio input signals INx will be described in further detail with respect to FIG. 3 below), a weighting unit 106 configured to weigh the early reflections identified in the first plurality of audio input signals IN or in the processed versions of the first plurality of audio input signals INx, and the reverberation identified in the first plurality of audio input signals IN or in the processed versions of the first plurality of audio input signals INx, and a merging unit 108 configured to assign the weighted early reflections identified in the first plurality of audio input signals IN or in the processed versions of the first plurality of audio input signals INx to a first subset of a second plurality of audio output signals OUT, and to assign the weighted reverberation identified in the first plurality of audio input signals IN or in the processed versions of the first plurality of audio input signals INx to a second subset of the second plurality of audio output signals OUT.

That is, reverberation and early reflections already present in the original audio signal (first plurality of audio input signals IN) are analyzed (e.g., reverberation parameters and early reflection parameters may be determined) and suitably distributed among the second plurality of audio output signals OUT. In this way, reverberation and early reflections already present in the first plurality of audio input signals IN are preserved. By suitably distributing reverberation and early reflections that are already present in the first plurality of audio input signals IN, the original ambience is not altered. For example, if the reverberation and early reflections included in the first plurality of audio input signals IN are characteristic for a specific type of listening environment, reverberation and early reflections present in the second plurality of audio output signals OUT will still be specific for the same type of listening environment. A type of environment may very generally relate to a size of the listening environment such as, e.g., small, medium-sized or large, or more specifically to a defined listening environment such as, e.g., a small/medium-sized/large church, a small/medium-sized/large jazz club, a small/medium-sized/large bar, a small/medium-sized/large concert hall, a small/medium-sized/large living room, a small/medium-sized/large stadium, etc. In other words, if, when listening to the first plurality of audio input signals IN, a user would get the impression of being located in a large concert hall, the user, when listening to the second plurality of audio output signals OUT, would still get the same impression of being located in a large concert hall. This similarly applies for any other kind of listening environment.

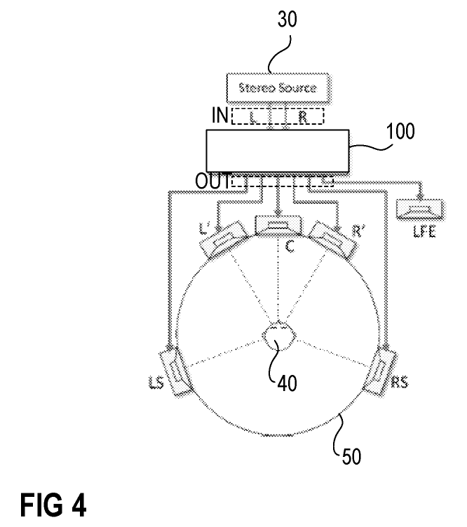

In FIG. 1, a single input signal IN and a single output signal OUT are schematically illustrated. However, there may be more than one input signal IN, and more than one output signal OUT, as is schematically illustrated in FIG. 4, for example. According to one example, the first plurality N of audio input signals IN may be or may consist of two channels (e.g., left (L) and right (R) channel) of a stereo audio signal. The second plurality M of audio output signals OUT may be or may consist of the different channels (e.g., front left (FL) channel, front right (FR) channel, center (C) channel, surround left (LS) channel, surround right (RS) channel) of an upmixed 5.1 surround signal. Any other number N of input signals IN, and any other number M of output signals OUT, with M ≥ N, however, is also possible. Reverberation may be added to each of a plurality of audio output signals OUT, or only to some of a plurality of audio output signals OUT. In a 5.1 surround signal, reverberation may only be added to the surround left, LS, and surround right, RS, channels of an upmixed 5.1 surround signal, to name just one example. The same applies for early reflections which may be added to each of the plurality of audio output signals OUT, or only to some of a plurality of audio output signals OUT. In a 5.1 surround signal, early reflections may only be added to front and side channels, FL, FR, C, of an upmixed 5.1 surround signal, to name just one example. Generally speaking, according to some embodiments, at least one audio output signal of the first subset may not be included in the second subset, and at least one audio output signal of the second subset may not be included in the first subset of the second plurality of audio output signals OUT.

Now referring to FIG. 2, an audio system 200 according to further embodiments of the disclosure is schematically illustrated. The audio system 200, in addition to the components as have been discussed with respect to FIG. 1 above, further comprises an ambience creation unit 204 configured to create additional early reflections and additional reverberation, based on the early reflections and reverberation identified in the first plurality of audio input signals IN or in the processed versions of the first plurality of audio input signals INx. The weighting unit 206 is further configured to weigh the additional early reflections and the additional reverberation, and the merging unit 208 is further configured to assign the weighted additional early reflections to the first subset of the second plurality of audio output signals OUT, and to assign the weighted additional reverberation to the second subset of the second plurality of audio output signals OUT.

That is, in addition to the reverberation and early reflections that are already present in the first plurality of audio input signals IN, artificial reverberation and artificial early reflections may be added to the second plurality of audio output signals OUT. Artificial reverberation and artificial early reflections, however, are not randomly added. Additional artificial early reflections and additional artificial reverberation are created based on the early reflections and reverberation identified in the first plurality of audio input signals IN. That is, if the reverberation and early reflections that are present in the first plurality of audio input signals IN are identified to be specific for a certain type of listening environment, artificial reverberation and early reflections are created and subsequently added that are typical for the same type of listening environment. In this way, an ambience present in the first plurality of audio input signals IN is preserved and is also present in the second plurality of audio output signals OUT. The artificial reverberation generally is identical or at least highly similar to the reverberation originally included in the first plurality of audio input signals IN (e.g., with respect to decay time and/or initial level of reverb tail). Similarly, the artificial early reflections generally are identical or at least highly similar to the early reflections originally included in the first plurality of audio input signals IN (e.g., with respect to time delay for each reflection and/or level of each reflection).

For example, a defined amount of reverberation and a defined amount of early reflections may be included in the first plurality of audio input signals IN. The reverberation and early reflections included in the first plurality of audio input signals IN each may have a specific pattern that is characteristic for a certain listening environment. The amount of reverberation and the amount of early reflections included in the first plurality of audio input signals IN, and/or their specific patterns, may be identical or at least highly similar to the amount of reverberation and early reflections, and/or their specific patterns, included in the second plurality of audio output signals OUT. According to some embodiments, ambience (reverberation and early reflections) in the second plurality of audio output signals may be set to match a specified target ambience level.

Generally, any suitable program and/or algorithm may be used for identifying and/or analyzing early reflections and reverberation present in the first plurality of audio input signals IN or in processed versions of the first plurality of audio input signals INx. According to some examples, deep learning, DL, classification algorithms may be used for identifying and/or analyzing early reflections and reverberation present in the first plurality of audio input signals IN or in processed versions of the first plurality of audio input signals INx. A deep learning, DL, classification algorithm may be based on a deep learning, DL, model, wherein the DL model is trained using annotated data consisting of audio signals with different known grades of reverberation, for example. The DL model may learn hierarchical representations from input samples, for example. In order to be able to identify reverberation classes in audio signals with a high accuracy, it may be trained with annotated data consisting of audio signals with different known grades of reverberation. The grades of reverberation may be perceptually measured, for example. One or more different databases may generally be used for this purpose. The one or more databases may be obtained in any suitable way.

The weighting unit 106, 206 may be configured to perform the weighting based on at least one external trigger, to modify the amount of early reflections and the amount of reverberation assigned to the first subset and the second subset, respectively. For example, the audio system 100, 200 may be arranged in a listening environment, and the at least one external trigger may comprise at least one of a noise level in the listening environment, a size of the listening environment, and user preferences. For example, if reverberation is not weighted (e.g., not amplified) and there is a great amount of background noise (e.g., any kind of driving noise in a vehicle), reverberation may not be perceivable for a user of the audio system 100, 200 in specific cases. Therefore, reverberation and/or early reflections may be weighted such that they are not masked by the background noise present in the listening environment. Further, a size of the listening environment may be considered during the weighting process, as reverberation and early reflections also occur within the listening environment which may overlap with reverberation and early reflections present in the second plurality of audio output signals OUT. A spectral distribution and a delay of the reverberation and early reflections may also have an influence on the weighting process performed by the weighting unit 106, 206. Additionally or alternatively, user preferences may also be considered. If no external trigger is available (e.g., noise level in and size of the listening environment not known, no user preferences available), default parameters may be used during the weighting process. According to some examples, if no external trigger is available, reverberation and/or early reflections may remain unchanged during the weighting process (e.g., weighting factor = 1).

As has been described above, the ambience analysis unit 102, 202 is configured to identify and/or analyze early reflections and reverberation present in a first plurality of audio input signals IN or in processed versions of the first plurality of audio input signals INx. The audio system 100, 200, therefore, may further comprise a residual extraction unit 210 configured to remove center channel components from the first plurality of input signals IN in order to generate the processed versions of the first plurality of audio input signals INx. This is schematically illustrated in FIG. 3. Reverberation and early reflections are usually not included in the center channel components of audio signals. That is, by removing center channel components from the first plurality of input signals IN, only residual components of the first plurality of audio input signals IN remain, which include any reverberation and early reflections present in the first plurality of audio input signals IN.

The audio systems described above may be surround sound systems, or any kind of 3D audio systems (e.g., VR/AR applications), for example. That is, the number N of audio input signals included in the first plurality of audio input signals IN may equal the number M of audio signals included in the second plurality of audio output signals OUT (N = M). It is, however, also possible that the number N of audio input signals included in the first plurality of audio input signals IN is less than the number M of audio signals included in the second plurality of audio output signals OUT (N < M). That is, the audio system 100, 200 may be or may comprise an upmixing processor.

A surround sound system is schematically illustrated in FIG. 4. The surround sound system comprises a stereo source 30. The audio system 100 may receive a first plurality of audio input signals IN from the stereo source 30, e.g., two channels (left (L) and right (R) channel) of a stereo audio signal. The second plurality of audio output signals OUT may consist of the different channels (e.g., front left (L’) channel, front right (R’) channel, center (C) channel, surround left (LS) channel, surround right (RS) channel) of an upmixed 5.1 surround signal. A plurality of loudspeakers may be arranged in a listening environment 50. The loudspeakers may be arranged at suitable positions with respect to a listener 40 present in the listening environment 50. The different channels of the second plurality of audio output signals OUT may be fed to the respective loudspeakers. A surround sound system as exemplarily illustrated in FIG. 4, may generate artificial spatiality (ambience) in order to achieve an acoustic envelopment of the listener 40 in the listening environment 50. The output signals generated by the surround sound system may be routed to the surround and height channels of a multi-channel speaker system.

Artificial reverberation and early reflections to be added to the one or more audio output signals OUT may be generated in any suitable way. The artificially generated reverberation any early reflections may be then fed to the merging unit 108, 208 of the audio system 100, 200. The merging unit 108, 208 may route the reverberation and early reflections (“ambience” signal components) to the desired speakers (e.g., the front, side, surround and/or height speakers of a surround sound system) according to a desired upmixing setting.

It is, however, also possible that the audio system 100, 200 comprises or is coupled to a memory (not specifically illustrated), wherein different types of reverberation and early reflections are stored in the memory. The audio system 100, 200, can retrieve a suitable reverberation and early reflections from the memory and add it to the one or more audio output signals OUT accordingly.

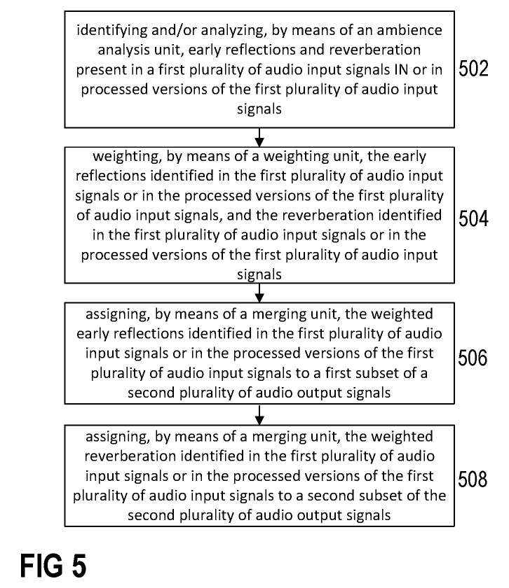

Referring to FIG. 5, a method according to embodiments of the disclosure comprises identifying and/or analyzing, by means of an ambience analysis unit 102, 202, early reflections and reverberation present in a first plurality of audio input signals IN or in processed versions of the first plurality of audio input signals Inx (step 502). The method further comprises weighting, by means of a weighting unit 106, 206, the early reflections identified in the first plurality of audio input signals IN or in the processed versions of the first plurality of audio input signals INx, and the reverberation identified in the first plurality of audio input signals IN or in the processed versions of the first plurality of audio input signals Inx (step 504). The method further comprises assigning, by means of a merging unit 108, 208, the weighted early reflections identified in the first plurality of audio input signals IN or in the processed versions of the first plurality of audio input signals INx to a first subset of a second plurality of audio output signals OUT (step 506), and assigning, by means of a merging unit 108, 208, the weighted reverberation identified in the first plurality of audio input signals IN or in the processed versions of the first plurality of audio input signals INx to a second subset of the second plurality of audio output signals (step 508).

According to some embodiments of the disclosure, the method further comprises creating, by means of an ambience creation unit 204, additional early reflections and additional reverberation, based on the early reflections and reverberation identified in the first plurality of audio input signals IN or in the processed versions of the first plurality of audio input signals INx, weighting, by means of the weighting unit 206, the additional early reflections and the additional reverberation, and assigning, by means of the merging unit 208, the weighted additional early reflections to the first subset of the second plurality of audio output signals OUT, and the weighted additional reverberation to the second subset of the second plurality of audio output signals OUT.

It may be understood, that the illustrated systems are merely examples. While various embodiments of the disclosure have been described, it will be apparent to those of ordinary skill in the art that many more embodiments and implementations are possible within the scope of the disclosure. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof. Accordingly, the disclosure is not to be restricted except in light of the attached claims and their equivalents.

The description of embodiments has been presented for purposes of illustration and description. Suitable modifications and variations to the embodiments may be performed in light of the above description or may be acquired from practicing the methods. The described arrangements are exemplary in nature, and may include additional elements and/or omit elements. As used in this application, an element recited in the singular and proceeded with the word “a” or “an” should be understood as not excluding plural of said elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature, and may include additional elements and/or omit elements. The subject matter of the present disclosure includes all novel and non-obvious combinations and sub-combinations of the various systems and configurations, and other features, functions, and/or properties disclosed. The following claims particularly point out subject matter from the above disclosure that is regarded as novel and non-obvious.

What is claimed is:

1. An audio system comprising:
an ambience analysis unit configured to identify early reflections and reverberation present in a first plurality of audio input signals or in processed versions of the first plurality of audio input signals;
a weighting unit configured to weight the early reflections identified in the first plurality of audio input signals or in the processed versions of the first plurality of audio input signals, and weight the reverberation identified in the first plurality of audio input signals or in the processed versions of the first plurality of audio input signals; and
a merging unit configured to assign the weighted early reflections identified in the first plurality of audio input signals or in the processed versions of the first plurality of audio input signals to a first subset of a second plurality of audio output signals, and to assign the weighted reverberation identified in the first plurality of audio input signals or in the processed versions of the first plurality of audio input signals to a second subset of the second plurality of audio output signals.

2. The audio system of claim 1, further comprising an ambience creation unit configured to create additional early reflections and additional reverberation, based on the early reflections and reverberation identified in the first plurality of audio input signals or in the processed versions of the first plurality of audio input signals, wherein:
the weighting unit is further configured to weight the additional early reflections and the additional reverberation; and
the merging unit is further configured to assign the weighted additional early reflections to the first subset of the second plurality of audio output signals, and to assign the weighted additional reverberation to the second subset of the second plurality of audio output signals.

3. The audio system of claim 1, wherein at least one audio output signal of the first subset is not included in the second subset, and at least one audio output signal of the second subset is not included in the first subset

4. The audio system of claim 1, wherein the weighting unit is configured to perform the weighting based on at least one external trigger, to modify an amount of early reflections and an amount of reverberation assigned to the first subset and the second subset, respectively.

5. The audio system of claim 4, wherein the audio system is arranged in a listening environment, and the at least one external trigger comprises at least one of a noise level in the listening environment, a size of the listening environment, and user preferences.

6. The audio system of claim 1, wherein a number of audio input signals included in the first plurality of audio input signals or in the processed versions of the first plurality of audio input signals is equal to or less than a number of audio output signals included in the second plurality of audio output signals.

7. The audio system of claim 6, wherein the first plurality of audio input signals or the processed versions of the first plurality of audio input signals consists of two channels of a stereo audio signal, and wherein the second plurality of audio output signals consists of five channels of an upmixed 5.1 surround signal.

8. The audio system of claim 7, wherein the merging unit is configured to assign early reflections only to front and side channels of the second plurality of audio output signals, and to assign reverberation only to rear channels of the second plurality of audio output signals.

9. The audio system of claim 1, further comprising a residual extraction unit configured to extract center channel components from the first plurality of input signals in order to generate the processed versions of the first plurality of audio input signals.

10. A method comprising:
identifying, using an ambience analysis unit, early reflections and reverberation present in a first plurality of audio input signals or in processed versions of the first plurality of audio input signals;
weighting, using a weighting unit, the early reflections identified in the first plurality of audio input signals or in the processed versions of the first plurality of audio input signals, and the reverberation identified in the first plurality of audio input signals or in the processed versions of the first plurality of audio input signals; and
assigning, using a merging unit, the weighted early reflections identified in the first plurality of audio input signals or in the processed versions of the first plurality of audio input signals to a first subset of a second plurality of audio output signals, and assigning, by means of a merging unit, the weighted reverberation identified in the first plurality of audio input signals or in the processed versions of the first plurality of audio input signals to a second subset of the second plurality of audio output signals.

11. The method of claim 10, further comprising
creating, using an ambience creation unit, additional early reflections and additional reverberation, based on the early reflections and reverberation identified in the first plurality of audio input signals or in the processed versions of the first plurality of audio input signals;
weighting, using the weighting unit, the additional early reflections and the additional reverberation; and
assigning, using the merging unit, the weighted additional early reflections to the first subset of the second plurality of audio output signals, and the weighted additional reverberation to the second subset of the second plurality of audio output signals.

12. The method of claim 10, wherein at least one audio output signal of the first subset is not included in the second subset, and at least one audio output signal of the second subset is not included in the first subset.

13. The method of claim 10, wherein the weighting is performed based on at least one external trigger comprising at least one of a noise level in a listening environment, a size of the listening environment, and user preferences.

14. The method of claim 13, wherein the weighting is performed such that the early reflections and the reverberation are weighted to avoid being masked by background noise present in the listening environment.

15. The method of claim 10, wherein identifying and/or analyzing the early reflections and reverberation comprises using a deep learning classification algorithm trained with audio signals having known grades of reverberation.

16. The method of claim 10, further comprising extracting, using a residual extraction unit, center channel components from the first plurality of audio input signals to generate the processed versions of the first plurality of audio input signals.

17. The method of claim 10, wherein the first plurality of audio input signals consists of two channels of a stereo audio signal and the second plurality of audio output signals consists of five channels of an upmixed 5.1 surround signal.

18. The method of claim 17, wherein assigning includes routing early reflections only to front and side channels of the upmixed 5.1 surround signal, and routing reverberation only to rear channels of the upmixed 5.1 surround signal.

19. The method of claim 11, further comprising retrieving at least one of the additional early reflections and the additional reverberation from a memory.

20. A non-transitory computer-readable medium comprising instructions that, when executed by a processor, cause the processor to perform an audio processing method, the method comprising:
identify early reflections and reverberation present in a first plurality of audio input signals or in processed versions of the first plurality of audio input signals;
weighting the early reflections identified in the first plurality of audio input signals or in the processed versions of the first plurality of audio input signals, and the reverberation identified in the first plurality of audio input signals or in the processed versions of the first plurality of audio input signals; and
assigning the weighted early reflections identified in the first plurality of audio input signals or in the processed versions of the first plurality of audio input signals to a first subset of a second plurality of audio output signals; and
assigning the weighted reverberation identified in the first plurality of audio input signals or in the processed versions of the first plurality of audio input signals to a second subset of the second plurality of audio output signals.
